(19) United States
(12) Patent Application Publication
(10) Pub. No.: US 2024/0147506 A1
(43) Pub. Date: May 2, 2024

(54) DYNAMIC SL RESOURCE ALLOCATION

(71) Applicant: MEDIATEK INC., Hsinchu City (TW)

(72) Inventors: Guan-Yu Lin, Hsinchu City (TW); Chia-Hao Yu, Hsinchu City (TW)

(21) Appl. No.: 18/486,065

(22) Filed: Oct. 12, 2023

Related U.S. Application Data
(60) Provisional application No. 63/381,765, filed on Nov. 1, 2022.

(51) Int. Cl. H04W 72/40; H04W 28/26; H04W 76/14

(52) U.S. Cl. CPC H04W 72/40; H04W 28/26; H04W 76/14

(57) ABSTRACT

Apparatus and methods are provided for dynamic sidelink (SL) resource allocation. In one novel aspect, one or more uplink (UL) resources are allocated for SL transceiving. In one embodiment, the UE establishes an SL connection with an SL peer UE, receives an allocation indication indicating one or more UL resources are available as shared SL resources for SL transceiving, wherein the allocation indication is originated from a gNB, and performs SL data transceiving with the SL peer UE using the one or more UL resources indicated in the allocation indication. In one embodiment, the UE receives the allocation indication through the Uu connection by unicast, multicast or broadcast. In one embodiment, the shared SL resources are indicated by RB ID or by SL grants. In one embodiment, conditions for using the shared SL resources are included in the allocation indication or are indicated in a separate RRC configuration.

### CROSS REFERENCE TO RELATED APPLICATIONS

This application claims priority under 35 U.S.C. § 119 from U.S. Provisional Application No. 63/381,765 entitled “Dynamic SL Resource Allocation,” filed on Nov. 1, 2022. The disclosure of each of the foregoing documents is incorporated herein by reference.

### TECHNICAL FIELD

The disclosed embodiments relate generally to wireless communication, and, more particularly, dynamic sidelink (SL) resource allocation.

### BACKGROUND

Sidelink (SL) communication was introduced to enable direct transmission between two user equipments (UEs), which is also known as the device-to-device (D2D) communications. With the development of 3GPP normative works, the scenarios of sidelink are extended to UE-to-network relay, public safety, vehicle-to-everything (V2X) communications and so on. The critical role of sidelink in long term evolution (LTE) and the new radio (NR) has made it an inevitable remedy to support diverse use cases of future wireless communications.

With the SL communication, the UE can establish indirect path with the wireless network through the SL relay link. Problems occurs when there are insufficient SL resources in certain scenarios. It results in low SL data rate, which causes limited throughput performance. On the other hand, at the same time when the SL resources are restrained, there are available UL resources that are underutilized.

Improvements and enhancements are required to use the UL and SL resources more efficiently.

### SUMMARY

Apparatus and methods are provided for dynamic sidelink (SL) resource allocation. In one novel aspect, one or more uplink (UL) resources are allocated for SL transceiving. In one embodiment, the UE establishes an SL connection with an SL peer UE, receives an allocation indication indicating one or more uplink (UL) resources are available as shared SL resources for SL transceiving, wherein the allocation indication is originated from a gNB of the wireless network, and performs SL data transceiving with the SL peer UE using the one or more UL resources indicated in the allocation indication. In one embodiment, the UE receives the allocation indication through the Uu connection by unicast, multicast or broadcast. In one embodiment, a new radio network temporary identifier (RNTI) is used for the shared SL resources is used for multicast and/or broadcast. In one embodiment, the shared SL resources are indicated by resource block (RB) ID or by SL grants. In one embodiment, conditions for using the shared SL resources are included in the allocation indication or are indicated in a separate RRC configuration. In one embodiment, the UE is a relay UE, and wherein the UE receives the allocation indication from the gNB through a Uu link with the gNB. In one embodiment, the relay UE forwards the allocation indication to the SL peer UE through the SL connection or sends indication for the shared resource to the SL peer UE based on the allocation indication. In one embodiment, the SL peer UE has a Uu link with a second gNB and receives a second allocation indication from the second gNB indicating a second sets of UL resources available as SL shared resources, and wherein the UE and the SL peer UE exchanges at least one of corresponding allocation indication and corresponding conditions for the corresponding shared SL resources. In another embodiment, only overlapping resources of the shared SL resources and the second shared SL resources are used for the SL transceiving.

In one novel aspect, the base station allocates one or more uplink (UL) resources as shared SL resources, transmits an allocation indication to one or more UEs in the wireless network, wherein the allocation indication indicates the one or more UL resources as shared SL resources available for SL transceiving. In one embodiment, the allocation indication is transmitted by the gNB through downlink control information (DCI), MAC control element (CE) or radio resource control (RRC) message. In one embodiment, conditions for using the shared SL resources are included in the allocation indication or are indicated in a separate RRC configuration.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports dynamic SL resource allocation in accordance with embodiments of the current invention.

FIG. 2 illustrates exemplary message diagrams for signaling of dynamic SL resource scheduling in accordance with embodiments of the current invention.

FIG. 3 illustrates exemplary diagrams for allocation indication from the network in accordance with embodiments of the current invention.

FIG. 4 illustrates exemplary diagrams for detailed Uu interface messages and sidelink messages in accordance with embodiments of the current invention.

FIG. 5 illustrates exemplary message diagram for inter-gNB dynamic SL resource allocation in accordance with embodiments of the current invention.

FIG. 6 illustrates an exemplary message flow chart for the UE to perform the dynamic SL resource allocation in accordance with embodiments of the current invention.

FIG. 7 illustrates an exemplary message flow chart for the base station to perform the dynamic SL resource allocation in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system. Also please note that although some embodiments are described in 5G context, the invention can be applied to 6G or other radio access technology.

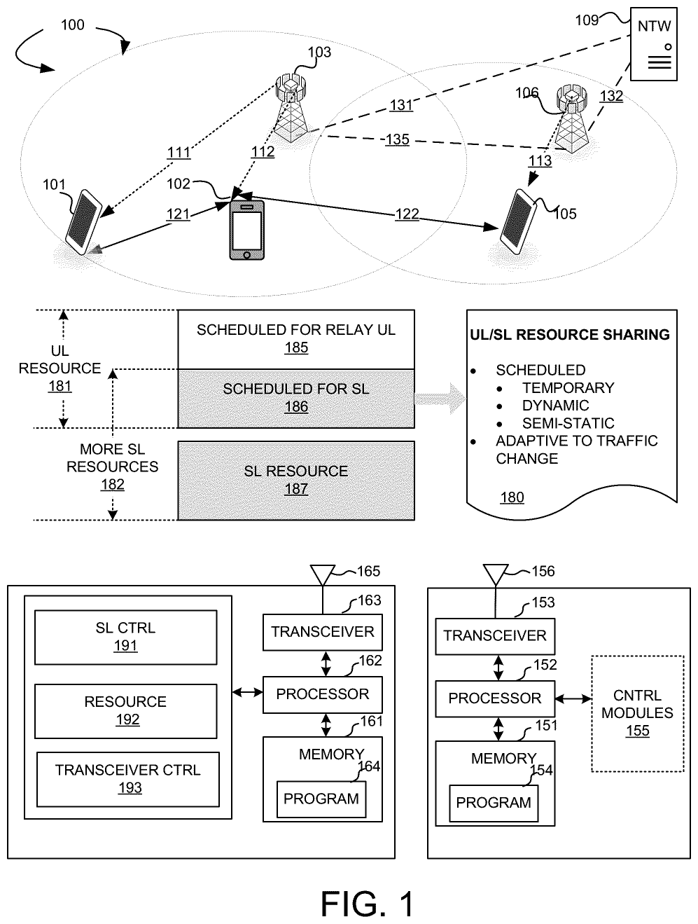

FIG. 1 is a schematic system diagram illustrating an exemplary wireless network that supports dynamic SL resource allocation in accordance with embodiments of the current invention. Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 103 and 106 are base stations in the wireless network. A network entity 109 connects with gNB 103 and 106 via NG connection 131 and 132, respectively. gNB 103 and 106 are connected through Xn interface 135. UE 101 and 102 both have Uu links with gNB 103, such as Uu link 111 and Uu link 112. UE 105 is connected with gNB 106 with Uu link 113. UE 101 and UE 102 also established SL 121. UE 105 and UE 102 establishes SL 122. In some scenarios, when the sidelink, such as SL 121, has limited SL throughput, UE 101 performs data transceiving with the direct Uu link, such as link 111. While in other scenarios, when there is sufficient SL throughput, the indirect path, such as SL 121 and Uu 112, are selected for the connection. Similarly, UE 105, which is connected with a different gNB, can establish relay link with gNB 103 through relay UE 102 via SL 122 and Uu link 112.

In one novel aspect 180, UL resources are allocated as shared SL resources. As illustrated, UL resource 181 and SL resource 187 are configured. When the system detects one or more trigger events, such as detecting insufficient SL resources and/or when UL resource is with low utilization, one or more UL resources are configured as shared SL resources. As a result, UL resource 181 is configured with UL resources 185, which are scheduled for relay UL and UL resources 186, which are scheduled for SL. The remote UE gets more SL resources (182) for transceiving. The UL/SL resource sharing can be scheduled as temporary and be scheduled dynamically or semi-statically. The UL/SL resource sharing is configured to be adaptive to traffic change. The UL resources configured as shared SL resources could be configured based on traffic information.

FIG. 1 further illustrates simplified block diagrams of a base station and a mobile device/UE that supports UE-assisted report. gNB 103 has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 103. Memory 151 stores program instructions and data 154 to control the operations of gNB 106. gNB 103 also includes a set of control modules 155 that carry out functional tasks to communicate with mobile stations. These control modules can be implemented by circuits, software, firmware, or a combination of them.

FIG. 1 also includes simplified block diagrams of a UE, such as UE 101. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver 163 may comprise two RF modules (not shown) which are used for different frequency bands transmitting and receiving. RF transceiver 163 also converts received baseband signals from processor 162, converts them to RF signals, and sends out to antenna 165. Processor 162 processes the received baseband signals and invokes different functional modules to perform features in UE 101. Memory 161 stores program instructions and data 164 to control the operations of UE 101. Antenna 165 sends uplink transmission and receives downlink transmissions to/from antenna 156 of gNB 103.

The UE also includes a set of control modules that carry out functional tasks. These control modules can be implemented by circuits, software, firmware, or a combination of them. A sidelink controller 191 establishes an SL connection with an SL peer UE in the wireless network. A resource module 192 receives an allocation indication indicating one or more uplink (UL) resources are available as shared SL resources for SL transceiving, wherein the allocation indication originates from a gNB of the wireless network. A transceiving controller 193 performs SL data transceiving with the SL peer UE using the one or more UL resources indicated in the allocation indication.

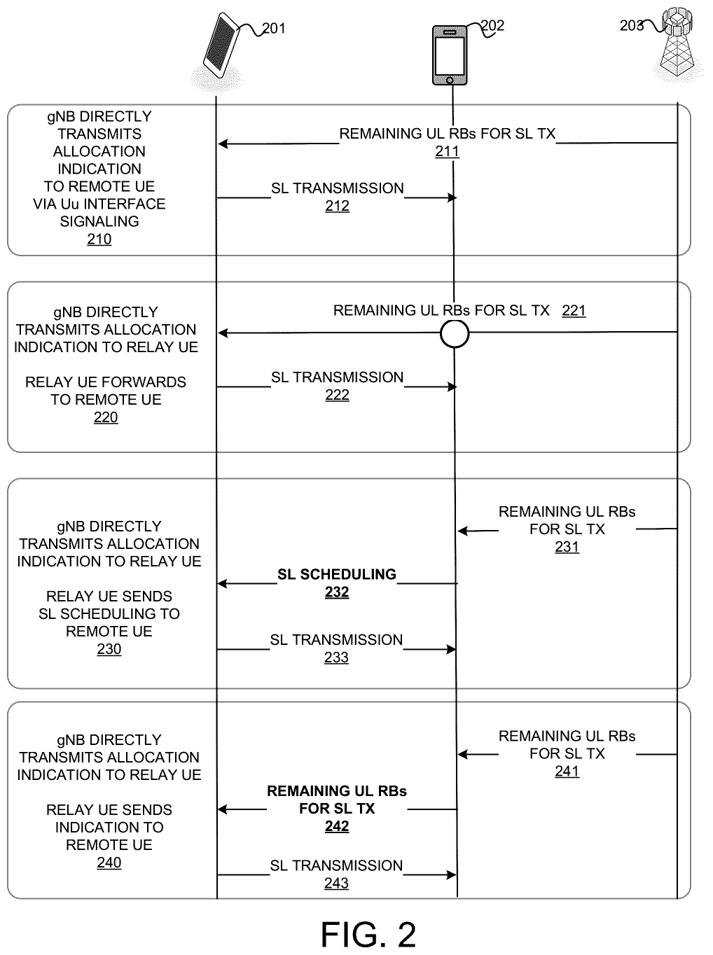

FIG. 2 illustrates exemplary message diagrams for signaling of dynamic SL resource scheduling in accordance with embodiments of the current invention. Remote UE 201 establishes sidelink connection with relay UE 202. Relay UE 202 has Uu interface connection with gNB 203. In one embodiment, remote UE 201 also establishes Uu interface connection with gNB 203. In one novel aspect, the network entity, such gNB 203 schedules one or more UL resources as shared SL resources for sidelink transmission. In one embodiment 210, gNB 203 signals the available resource information to remote UE 201 directly. At step 211, gNB 203 sends remaining UL RBs information for SL transmission to remote UE 201 directly through Uu interface signaling. At step 212, remote UE 201 transmits data packets to relay UE 202 using the allocated shared SL resources indicated in the message at step 211. In another embodiment 220, gNB 203 transmits the allocation indication to relay UE 202 directly and the relay UE forwards the indication to remote UE 201. At step 221, gNB 203 sends allocation indication indicating remaining UL RBs for SL transceiving through Uu interface signaling to relay UE 202 directly. Relay UE 202 forwards the allocation indication to remote UE 201 through SL connections. At step 222, remote UE 201 transmits data packets to relay UE 202 using the UL resources indicated in the allocation indication for shared SL resources. In another embodiment 230, gNB 203 transmits the allocation indication to relay UE 202 directly and the relay UE sends SL scheduling to remote UE 201 based on the allocation indication. At step 231, gNB 203 sends allocation indication indicating remaining UL RBs for SL transceiving through Uu interface signaling to relay UE 202 directly. At step 232, relay 202 sends SL scheduling to remote UE 201. The SL scheduling includes the one or more UL resources indicated in the allocation indication received from gNB 203. In one embodiment, the SL scheduling includes a subset of the one or more UL resources indicated in the allocation indication received from gNB 203. At step 233, remote UE 201 transmits data packets to relay UE 202 using the shared SL resources indicated in the SL scheduling received from relay UE 202. In one embodiment 240, gNB 203 transmits the allocation indication to relay UE 202 directly and the relay UE sends SL scheduling to remote UE 201 based on the allocation indication. At step 241, gNB 203 sends allocation indication indicating remaining UL RBs for SL transceiving through Uu interface signaling to relay UE 202 directly. At step 242, relay 202 sends allocation indication indicating remaining UL RBs for SL transceiving to remote UE 201. The allocation indication from relay UE 202 includes the one or more UL resources indicated in the allocation indication received from gNB 203. In one embodiment, the allocation indication from relay UE 202 includes a subset of the one or more UL resources indicated in the allocation indication received from gNB 203. At step 243, remote UE 201 transmits data packets to relay UE 202 using the shared SL resources indicated in allocation indication from relay UE 202. In one embodiment, the gNB transmits the allocation indication to the remote UE via the packet forwarding of relay UE in a unicast manner, which means that the relay UE just forwards the allocation indication but does not know the content of the forwarded packet.

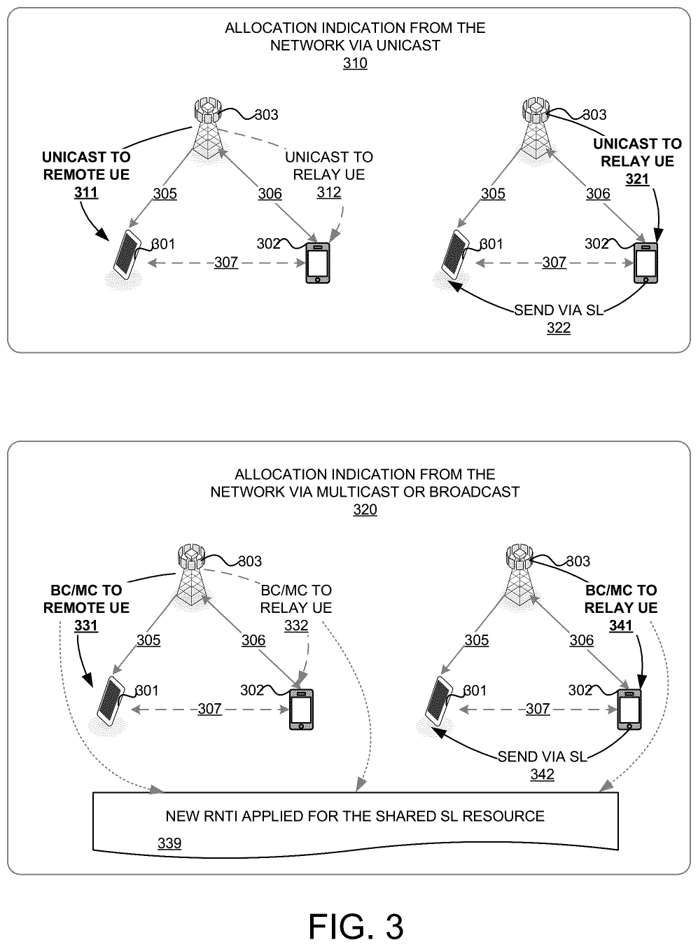

FIG. 3 illustrates exemplary diagrams for allocation indication from the network in accordance with embodiments of the current invention. In one novel aspect, the network initiated a dynamic SL resource allocation by allocating one or more UL resource as shared SL resources. The network initiates dynamic resource sharing through Uu interface signals. As an example, remote UE 301 establishes SL connection 307 with relay UE 302. Relay UE 302 establishes Uu interface connection 306 with gNB 303. In some scenarios, remote UE 301 also establishes Uu interface connection 305 with gNB 303. In one embodiment 310, the allocation indication is transmitted by the gNB via unicast. In one scenario, gNB 303 has direct Uu interface connection with remote UE 301. At step 311, gNB 303 transmits the allocation indication indicating available UL resources for SL transceiving to remote UE 301 through direct Uu interface connection 305. In one embodiment, at step 312, gNB 303 also transmits the allocation indication via unicast to relay UE 302. In another scenario, at step 321, gNB 303 transmits the allocation indication indicating available UL resources for SL transceiving to relay UE 302 through direct Uu interface connection 306. At step 322, relay UE 302 forwards the allocation indication to remote UE 301 through SL connection 307. In other embodiment, relay UE 302 sends the SL scheduling to remote UE 301 as described in step 232. In yet another embodiment, relay 302 sends allocation indication to remote UE 301 as described in step 242.

In another embodiment 320, the allocation indication is transmitted by the gNB via multicast or broadcast to one or more UEs. In one scenario, at step 331, gNB 303 multicast or broadcast the allocation indication indicating available UL resources for SL transceiving to remote UE 301 through direct Uu interface connection 305. In one embodiment 339, multicast or broadcast message applies a new radio network temporary identifier (RNTI) for shared SL resource in the allocation indication multicast/broadcast message. In this scenario, remote UE 331 receives the multicast/broadcast message directly from the Uu interface connection 305. In one embodiment, relay UE 302 also receives the multicast/broadcast message indicating available UL resources for SL transceiving directly from Uu interface connection 306. In another scenario, only relay UE 302 receives the multicast/broadcast message from gNB 303 indicating available UL resources for SL transceiving. At step 342, relay UE 302 forwards the allocation indication to remote UE 301 through SL connection 307. In other embodiment, relay UE 302 sends the SL scheduling to remote UE 301 as described in step 232. In yet another embodiment, relay 302 sends allocation indication to remote UE 301 as described in step 242.

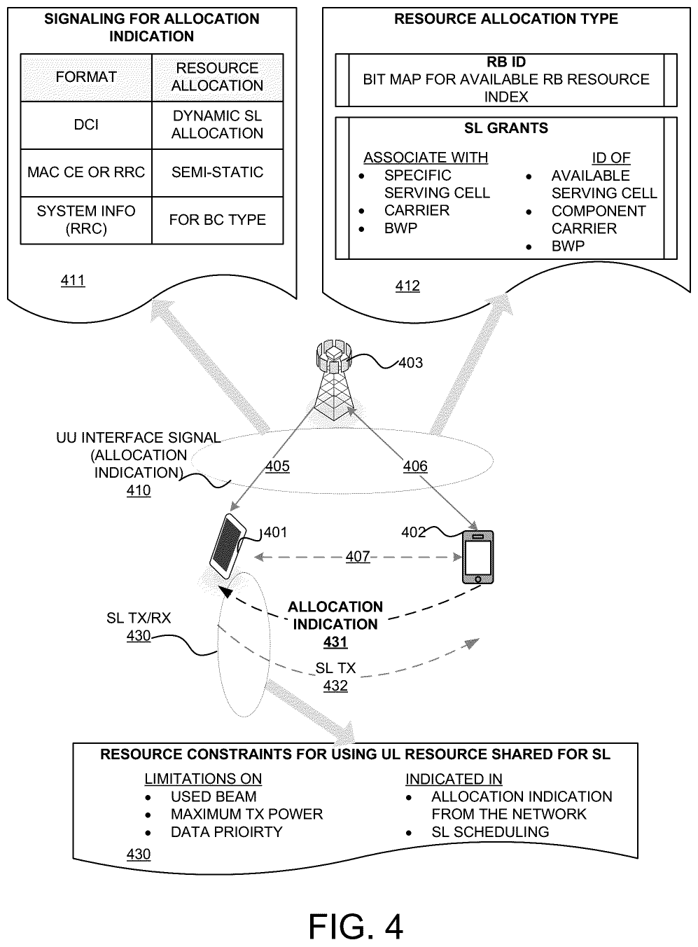

FIG. 4 illustrates exemplary diagrams for detailed Uu interface messages and sidelink messages in accordance with embodiments of the current invention. Remote UE 401 establishes SL connection 407 with relay UE 402. Relay UE 402 establishes Uu interface connection 406 with gNB 403. In one embodiment, remote UE 401 also establishes Uu interface connection 405 with gNB 401. In one embodiment, Uu interface signals 410 are used to transmit allocation indications to the relay UE and/or the remote for dynamic SL resource allocation.

In one embodiment 411, different formats are configured for the allocation indication. In embodiment, DCI is used for allocation indication from gNB. In one embodiment, DCI is used for dynamic SL resource allocation. DCI can also support fast cancellation for previously allocated SL resources. In another embodiment, MAC control element (CE) or RRC configuration is used for allocation indication. MAC CE or RRC configuration could be used for a more semi-static resource allocation. In yet another embodiment, RRC configuration for allocation indication is through system information, such as for multicast/broadcast messages. The system information that is used to update available SL resource may be subject to a modification period similar to how system information is updated in the wireless system, such as NR or LTE.

In one embodiment 412, the resource types are indicated through resource block (RB) ID or through SL grants (for the time-frequency resource). The RB ID may be indicated with a bit map indicating availability of RB resource indexes. For the SL grants, the resources may be associated with a specific serving cell, carrier or bandwidth part (BWP). The corresponding IDs of available serving cell, component carrier, and/or BWP are included indicating the resource type. In one embodiment, the UE may use a subset/partial or all of the resources indicated in the allocation indication.

In one embodiment, the shared SL resources indicated in the allocation indication are used for SL transceiving via SL connection 407. For example, at step 431, relay UE 402 sends SL scheduling (as described in step 232) to remote UE 401. In one embodiment, relay UE 402 uses the whole or a subset of the shared SL resources indicated in the allocation indication from gNB 403 for the SL scheduling message. At step 432, remote UE 401 sends data packets to relay UE 402 using one or more shared SL resources indicated in the allocation indication from gNB 403. In one embodiment 430, additional constraints apply for using the shared SL resources. The limitations include the used beams, the maximum transmitting power, data priority, and other limitations. For example, the UE is limited to using the beams that are not directed to the base station to reduce possible interferences. As another example, the maximum transmitting power may be adjusted based on one or factors such as traffic load, distances from the base station and others, to reduce possible interferences. In other examples, the shared SL resources may be used only for high priority data transmissions to guarantee data delivery. Alternatively, the shared SL resources are configured to be used only for low priority data transmission. The resource restraints may be predefined or dynamically configured. The restraints may be configured by the network or are UE implementation specific, or a combination of both.

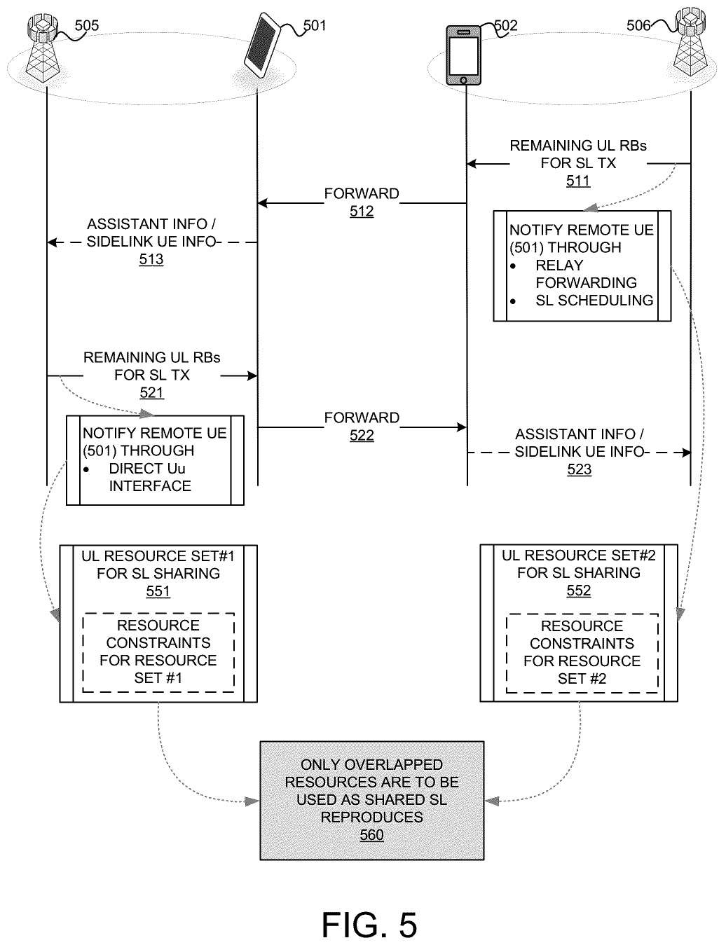

FIG. 5 illustrates exemplary message diagram for inter-gNB dynamic SL resource allocation in accordance with embodiments of the current invention. In one embodiment, the remote UE and the relay UE may be anchored/associated with different gNBs for dynamic SL resource allocation. In one embodiment, the remote UE and the relay UE exchanges the resource information and resource constraints information from corresponding base stations. Remote UE 501 establishes Uu interface connection with gNB 505. Relay UE 502 establishes Uu interface connection with a different base station, gNB 506. Remote UE 501 and relay 502 have an SL connection. At step 511, gNB 506 sends allocation indication of remaining UL RBs information for SL transmission to relay UE 502 directly through Uu interface signaling. In one embodiment, allocation indication is forwarded to remote UE 501 through direct forwarding (steps 221 and 22) or through SL scheduling (steps 231 and 232). At step 512, relay UE 502 forwards the allocation from gNB 506 to remote UE 501. At step 521, gNB 505 sends allocation indication of remaining UL RBs information for SL transmission to remote UE 501 directly through Uu interface signaling. In one embodiment, allocation indication is sent to remote UE 501 through direct Uu interface signaling (step 211). At step 522, remote UE 501 forwards the allocation indication from gNB 505 to relay UE 502. As an example, remote UE 501 receives UL resource set #1 551 for SL sharing from gNB 505, optional with resource constraints for resource set #1. Relay UE 502 receives UL resource set #2 552 for SL sharing from gNB 506, optional with resource constraints for resource set #2. In one embodiment 560, only overlapped resources (in resource set #1 and resource set #2) are used as shared SL transmission between UE 501 and UE 502. In another embodiment, the remote UE and/or the relay UE transmits the indication of available resources received from its SL peer UE to its corresponding gNB. The UE may treat the received allocation indication from peer SL UE as assistant information for mode-1 scheduling, which is the network scheduled/selected SL resource. In one embodiment, the UE transmits to its gNB by RRC message of UEAssistantInformation or SidelinkUEInformation. As an example, at step 513, after receiving from SL peer UE 502 the forwarded message, UE 501 sends RRC UEAssistantInformation or SidelinkUEInformation to gNB 505. At step 523, after receiving from SL peer UE 501 the forwarded message, UE 502 sends RRC UEAssistantInformation or SidelinkUEInformation to gNB 506. It is noted that the procedure is not limited to SL relay transceiving and can be used for general SL enhancement.

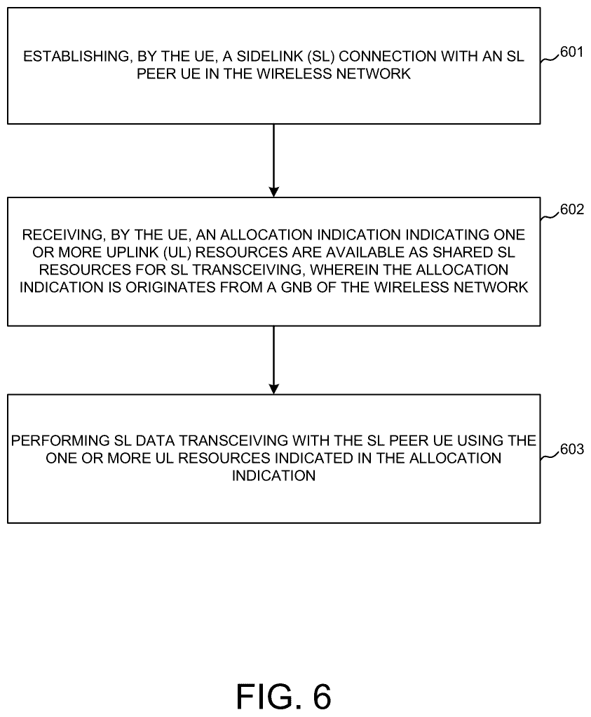

FIG. 6 illustrates an exemplary message flow chart for the UE to perform the dynamic SL resource allocation in accordance with embodiments of the current invention. At step 601, the UE establishes a sidelink (SL) connection with an SL peer UE in the wireless network. At step 602, the UE receives an allocation indication indicating one or more uplink (UL) resources are available as shared SL resources for SL transceiving, wherein the allocation indication originates from a gNB of the wireless network. At step 603, the UE performs SL data transceiving with the SL peer UE using the one or more UL resources indicated in the allocation indication.

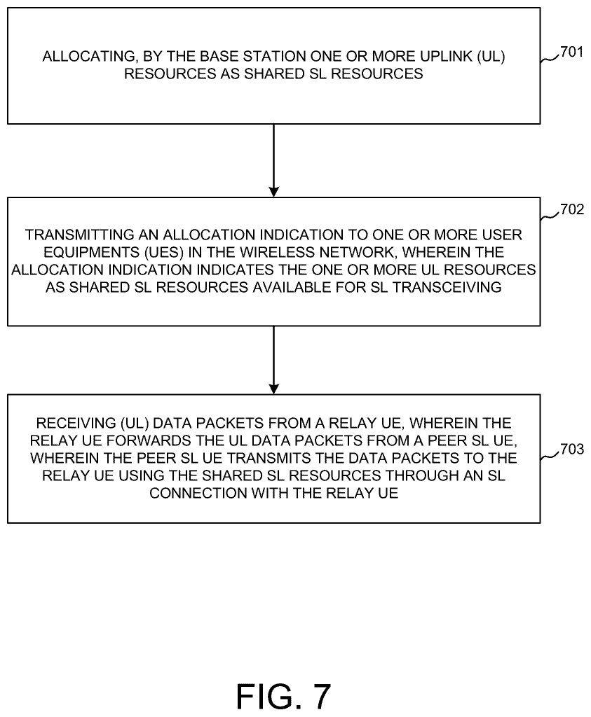

FIG. 7 illustrates an exemplary message flow chart for the base station to perform the dynamic SL resource allocation in accordance with embodiments of the current invention. At step 701, the base station allocates one or more uplink (UL) resources as shared SL resources. At step 702, the base station transmits an allocation indication to one or more UEs in the wireless network, wherein the allocation indication indicates the one or more UL resources as shared SL resources available for SL transceiving. At step 703, the base station receives data packets from a relay UE, wherein the relay UE forwards the UL data packets from a peer SL UE, wherein the peer SL UE transmits the data packets to the relay UE using the shared SL resources through an SL connection with the relay UE.

The allocation indication of available UL resource for SL resource transmission is not limited to only the relay scheme. It could be applied for a general SL enhancement. In one embodiment, a UE can broadcast or transmit the received allocation indication to another peer UEs even though there is no specific SL connection to the peer UE established. For example, a UE as a groupcast/multicast leader can periodically broadcast the allocation indication, if not expired, to its group members. For another example, a UE is just deployed to provide better SL coverage/throughput for its neighboring area and thus it broadcasts the received allocation indication for other peer UEs to use, even though there is no SL connection between this UE and other peer UE. In one example, a UE can send the received allocation indication when receiving request from other UE or when establishing a new SL connection with a new peer UE. A UE can transmit the received allocation indication periodically or based on some trigger conditions, e.g., when new allocation indication is received from the network.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) in a wireless network comprising:
establishing, by the UE, a sidelink (SL) connection with an SL peer UE in the wireless network;
receiving, by the UE, an allocation indication indicating one or more uplink (UL) resources are available as shared SL resources for SL transceiving, wherein the allocation indication originates from a gNB of the wireless network; and
performing SL data transceiving with the SL peer UE using the one or more UL resources indicated in the allocation indication.

2. The method of claim 1, wherein the allocation indication is transmitted by the gNB through downlink control information (DCI), MAC control element (CE) or radio resource control (RRC) message.

3. The method of claim 1, wherein the UE receives the allocation indication through the Uu connection by unicast, multicast or broadcast.

4. The method of claim 3, wherein the UE receives the allocation indication through multicast or broadcast, and wherein a new radio network temporary identifier (RNTI) is used for the shared SL resources.

5. The method of claim 1, wherein the shared SL resources are indicated by resource block (RB) ID or by SL grants.

6. The method of claim 1, wherein conditions for using the shared SL resources are included in the allocation indication or are indicated in a separate RRC configuration.

7. The method of claim 1, wherein the UE is a relay UE, and wherein the UE receives the allocation indication from the gNB through a Uu link with the gNB.

8. The method of claim 7, wherein the UE forwards the allocation indication to the SL peer UE through the SL connection.

9. The method of claim 7, wherein the UE sends indication for the shared resource to the SL peer UE based on the allocation indication.

10. The method of claim 1, wherein the SL peer UE has a Uu link with a second gNB and receives a second allocation indication from the second gNB indicating a second sets of UL resources available as SL shared resources, and wherein the UE and the SL peer UE exchanges at least one of corresponding allocation indication and corresponding conditions for the corresponding shared SL resources.

11. The method of claim 10, wherein only overlapping resources of the shared SL resources and the second shared SL resources are used for the SL transceiving.

12. A method for a base station in a wireless network comprising:
allocating, by the base station, one or more uplink (UL) resources as shared SL resources;
transmitting an allocation indication to one or more user equipments (UEs) in the wireless network, wherein the allocation indication indicates the one or more UL resources as shared SL resources available for SL transceiving; and
receiving (UL) data packets from a relay UE, wherein the relay UE forwards the UL data packets from a peer SL UE, wherein the peer SL UE transmits the data packets to the relay UE using the shared SL resources through an SL connection with the relay UE.

13. The method of claim 12, wherein the allocation indication is transmitted by the gNB through downlink control information (DCI), MAC control element (CE) or radio resource control (RRC) message.

14. The method of claim 12, wherein the allocation indication is transmitted through unicast, multicast or broadcast, and wherein a new radio network temporary identifier (RNTI) is used for the shared SL resources when transmitting in multicast or broadcast.

15. The method of claim 12, wherein the shared SL resources are indicated by resource block (RB) ID or by SL grants.

16. The method of claim 12, wherein conditions for using the shared SL resources are included in the allocation indication or are indicated in a separate RRC configuration.

17. A user equipment (UE), comprising:
a transceiver that transmits and receives radio frequency (RF) signal in a wide area wireless network;
a sidelink (SL) controller that establishes an SL connection with an SL peer UE in the wireless network;
a resource module that receives an allocation indication indicating one or more uplink (UL) resources are available as shared SL resources for SL transceiving, wherein the allocation indication originates from a gNB of the wireless network; and
a transceiving controller that performs SL data transceiving with the SL peer UE using the one or more UL resources indicated in the allocation indication.

18. The UE of claim 16, wherein the allocation indication is transmitted by the gNB through downlink control information (DCI), MAC control element (CE) or radio resource control (RRC) message.

19. The UE of claim 16, wherein the UE receives the allocation indication through the Uu connection by unicast, multicast or broadcast, and wherein a new radio network temporary identifier (RNTI) is used for the shared SL resources for the multicast or broadcast.

20. The UE of claim 16, wherein the shared SL resources are indicated by resource block (RB) ID or by SL grants.
